(19) United States
(12) Patent Application Publication
(10) Pub. No.: US 2006/0206616 A1
(43) Pub. Date: Sep. 14, 2006

(54) Decentralized secure network login

(75) Inventor: Aaron C. Brown, Ottawa (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(73) Assignee: GRIDIRON SOFTWARE, INC.

(21) Appl. No.: 11/374,043

(22) Filed: Mar. 14, 2006

Related U.S. Application Data
(60) Provisional application No. 60/661,005, filed on Mar. 14, 2005.

(51) Int. Cl. G06F 15/16

(52) U.S. Cl. 709/229

(57) ABSTRACT

A system and method for remote peer authentication make use of an exchange of user authentication information between a remote peer and an active peer in a peer-to-peer network. The active peer can authenticate the user based on the provided authentication information, and allow the remote peer to participate in the peer-to-peer network with all the privileges that the user would have if logged in locally.

### CROSS REFERENCE TO RELATED APPLICATIONS

This application claims the benefit of priority of U.S. Provisional Patent Application Ser. No. 60/661,005, filed Mar. 14, 2005, which is incorporated herein by reference in its entirety.

### FIELD OF THE INVENTION

The present invention relates generally to user login to a network. More particularly, the present invention relates to a system and method for allowing a user to remotely log in to a peer-to-peer network.

### BACKGROUND OF THE INVENTION

Network topologies are commonly divided between hierarchical networks, making use of a client-server relationship, and peer-to-peer networks, which make use of direct communication between two nodes in any given network.

Typically, a client-server network makes use of a centralized login procedure, where a user submits credentials to a server so that the server can authenticate the user and allow a login. Typically these credentials include a user name and a password combination but other credentials such as fingerprint scans and other biometric data can be used as well. The security of this system is well known, and though dependent upon the complexity of a password, it is considered sufficiently secure for most configurations. When users require remote access to the network, a variety of connection methods are permitted, including remote access using the same user name and password. The remotely submitted credentials are verified using either the same server or a server with a replicated credential database. To allow for additional security during remote login, some servers require the use of a generated token that indicates that the user is in possession of a token generator synchronized to the server.

In a peer-to-peer configuration, peers discover each other during initialization, and communicate directly to each other. Each peer in the network is responsible for administering its own credential challenge. Access to the resources of a peer in the network can be restricted to known peers, or logins at known peers. By removing the central server, users may lose the ability to log in from any system that they want, but also eliminate the central collection of user name and password pairs.

If a central server is compromised, all trust relationships built upon the propriety of the user name and password combinations stored by the server are compromised. If a malicious third party obtains access to the server, it is often not possible to determine which user accounts were accessed, and as a result, all trust relationships must be reset. This requires each user to be issued a new password, which is time intensive, and often results in the users attempting the change the password to the compromised password, a variant thereof, or a simpler password. None of these actions is desirable. Furthermore, servers require a certain complexity in the network design and is not considered practical in all environments.

As peer-to-peer networks grow, the interaction between the nodes becomes more complex, but unless there is high traffic destined for all nodes, such as a brute force search that examines all nodes in the network, the network congestion and complexity is very manageable. Thus, the addition of anew user is rarely of consequence to the network. In a client-server system, each new user added to the server is an additional burden to the server, which must maintain all of the trust relationships and profiles. In many client-server networks, there is a heavy demand placed upon the central server when a number of users attempt to log into the network in a short time span. Thus, many networks suffer a performance hit when users start a day or a shift. This load increases for each user supported by the server.

In a client server system, a user has the ability to log in from a number of different locations simultaneously. Thus, a user can log in to the network from a primary workstation, remain logged in, and proceed to log in to a system with access to a specific peripheral such as a scanner. The users can also log into the network remotely, and appear to other users of the network as the same entity. During each login the user can be provided with access to the same resources as they would during any other login. In a peer-to-peer network this is not the case. Because user authentication is done on a peer-by-peer basis, two different peers can support different users having the same user name. At best, identity is bound to a username and peer identifier combination. To allow a similar remote login scenario, each peer in the network would have to be provided with a complete list of the users and passwords of the other peers in the network. This would turn each peer into a potential point of failure in the trust relationship. If a single peer is compromised, the network trust relationships would have to be reset, which is an even more odious task, because the passwords would have to be synchronized between all the different nodes. This would also greatly increase the computing resources dedicated to login management at each peer.

It is, therefore, desirable to provide a system and method for allowing a decentralized secure network login in a peer-to-peer environment.

### SUMMARY OF THE INVENTION

It is an object of the present invention to obviate or mitigate at least one disadvantage of previous peer-to-peer network login mechanisms.

In a first aspect of the present invention there is provided a peer, for participation in a peer-to-peer network, and for remotely authenticating a request for an identity profile stored by the peer. The peer comprises a remote interface, a verification engine and an identity profile store. The remote interface receives an authentication request for the identity profile from a remote peer, the authentication request contains a challenge response. The verification engine verifies the challenge response received with the authentication request. The identity profile store stores the identity profile and releases the identity profile to the remote peer upon obtaining verification of a valid challenge response from the verification engine.

In embodiments of the first aspect of the present invention, the identity profile store includes means to release the identity profile to the remote peer through the remote interface. In other embodiments, the challenge response is a user identifier and password combination. The remote interface can include a relay server interface for providing an address associated with the remote peer to a relay server upon transmission of the identity profile to the remote peer. In other embodiments, the authentication request includes an encrypted token as the challenge response, the verification engine can include a decryption engine for decrypting the encrypted token to obtain a challenge response and the remote interface can include means to transmit the decrypted token to the remote peer upon verification of the challenge response by the verification engine using a secure connection.

In a second aspect of the present invention, there is provided a method of providing an identity profile to a requesting node in a network. The method comprises the steps of receiving from the requesting node a login request containing a token having a challenge response; verifying the challenge response in the token, and transmitting the verified token to the requesting node; receiving a request for an identity profile associated with the verified token from the remote node in response to transmission of the verified token; and transmitting the requested identity profile to the requesting node.

In embodiments of the second aspect of the present invention, the received token is encrypted and the step of verifying the challenge response can include decrypting the token and verifying the decrypted challenge response. In other embodiments, the steps of transmitting the verified token, receiving the request for the identity profile and transmitting the requested identity profile are performed over a secure transmission channel. In further embodiments, the method includes the step of providing a relay server with the address of the remote peer upon transmitting the requested identity profile.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a data flow diagram illustrating a method of the present invention;

FIG. 2 is a data flow diagram illustrating an authentication method of the present invention;

FIG. 3 is a data flow diagram illustrating a user enrolment method of the present invention;

FIG. 4 is a flowchart illustrating a method of obtaining a user profile according to an embodiment of the present invention; and

FIG. 5 is a block diagram of a peer for providing an identity profile according to an embodiment of the present invention.

### DETAILED DESCRIPTION

Generally, the present invention provides a method and system for remote user authentication.

Centralized login services typically require users to have access to the same set of login servers. As the user base of the login server grows, each additional user presents an additional incremental burden on the server, requiring that resources be scaled as the user base increases. Centralized servers typically store all the data in a single point of failure, so that compromise of a login server compromises all users of the server. To address these issues, the present invention provides a mechanism for a user to authenticate in a peer-to-peer network so that a user can maintain a single profile regardless of where he or she is logging in. The present invention allows a login using access to only one other peer where that user is logged in. This distributes the login burden, so that the burden of a user is presented only to the peers where that user is logged in. As a result, the resources necessary during login are independent of the number of actual users of a network. Each user is able to store credentials on his peer, and is able to authenticate in a manner that allows him to present the same credentials regardless of the system he is using. Compromise of a peer compromises only the credentials of a user of the peer, requiring only that peer's trust relationships to be reset.

In a peer-to-peer network, a user's identity is bound to a user identifier and peer identifier pairing. A peer in the network can extend resources either to all users of another peer or resources can be extended to particular users of that peer. In a crucial instance of this, a user is granted certain attributes by the node that her login is local to. Access to identity information not just applications is crucial. Whereas remote desktop control allows a user to remotely login to a peer, applications are not executed at the node in front of the user and are instead executed on the “home” node (that is, the node associated with the login information). Though this may be acceptable for low bandwidth tasks, it does not permit transfer or network identity to a local login on another peer.

To provide an overview of the present invention, consider a standard peer-to-peer network. Users login at peers, and are authenticated by the local peer. During the initialization process of the peer, the other peers on the network are notified that the peer is active, and the peer builds a map of available systems in the network. After logging in at a primary workstation, a user leaves that workstation and initiates a login at another peer. During this login however, the user does not attempt to create a new login to the network, and instead creates a connection to the already active peer that he is logged into. Using this connection, the user provides the primary workstation with the same credentials that he used during the initial login. This allows the primary workstation to authenticate the user, and allows the new login from the second system to be attached to the peer-to-peer network with the same privileges that would be afforded to the user as if he had logged in at the primary workstation. If the user wishes to create another login instance, a connection to either the primary workstation or the second system can be used to provide the same credentials again. When a message is passed to the user from another peer in the network, all systems that the user is active on, can serve as a reception point. The systems then relay the information to the other nodes that the user is logged in at to ensure that the user receives the message.

The present invention allows the user to subordinate the function of any software installed on a peer that he or she is already logged into. The login process to the already active peer can use any credential exchange, including but not limited to the username and password or passphrase used for the standard login and biometric data such as fingerprint scans. The present invention allows for secure retrieval of an identity profile from the active peer. This procedure is comprised of the following steps (A1 is the “home” peer and A2 is the current peer):

1. A₂: Locate another peer where user is currently logged in.

2. A₂: Create login request containing:
a) Signed location of A₂, and
b) Encrypted authentication token.

3. A₂: Send login request to A₁.

4. A₁: Verify location of A₂.

5. A₁: Connect anonymously to A₂.

6. A₁: Send decrypted authentication token to A₂.

7. A₂: Verify authentication token from A₁.

8. A₂: Request identity profile from A₁.

9. A₁: Send identity profile to A₂.

The existing peer-to-peer network can be provided with peer location brokering with endpoint ordering as described above, by each peer that the user is logged into communicating with the other peers to track the most recent access.

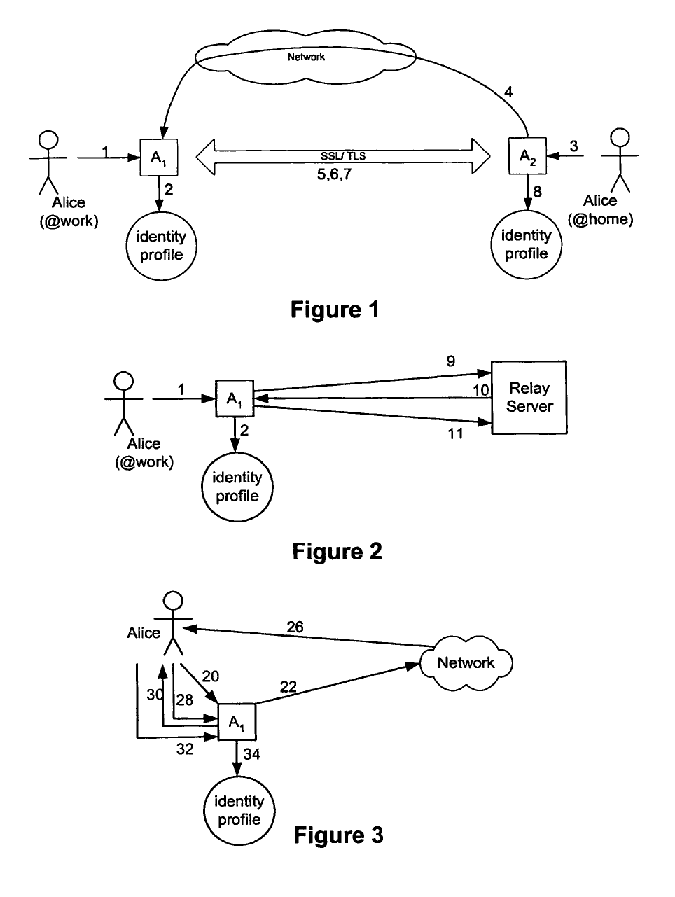

FIG. 1 illustrates an embodiment of the present invention where a user (Alice) remotely connects to a peer-to-peer network. Alice is already logged into a workstation in the office (indicated as @work). Alice (@work) indicates (1) that she will be using system A1 remotely. A1 updates Alice's identity profile (2) to permit remote identity access. Alice (@home) installs remote access keys on system A2 and logs in using her accepted credentials such as e-mail address and passphrase (3). A2 locates A1 (4) and sends signed location information along with an encrypted authentication token to A1. The key used to encrypt the token is known to A1, and allows A1 to determine that the submitted token is from a trusted source. A1 verifies location information for A2, establishes an anonymous SSL/TLS connection (5) to A2 and then transmits the decrypted authentication token to A2 over the secure link. A2 verifies that the authentication token from A1 corresponds to the encrypted token sent and then requests Alice's identity profile (6). A1 sends Alice's identity profile to A2 (7). A2 preserves Alice's identity profile for use (8).

This allows Alice to access any network resources accessible to her identity. Applications, such as messaging software, group based application software and other such applications can be accessed and executed from system A2 while preserving Alice's identity from A1.

FIG. 2 illustrates a local login for the present invention. In data flow 1, Alice starts a peer-based application and enters credentials such as an e-mail address and passphrase. In data flow 2, system A unlocks Alice's profile using her passphrase. In dataflow 9, system A sends location information to a relay server (R/S). In dataflow 10, R/S responds to A with the R/S's view of A's network endpoint. In dataflow 11, system A signs location information and sends it to R/S. This allows system A, and R/S/ to determine the systems where Alice is logged in. This facilitates message passing to allow active instances of Alice's identity on the network.

FIG. 3 illustrates the process of a user enrolling in a system to permit remote peer logins. One of the primary concerns with a system that uses email addresses for credentials as part of a login, is that a check must be performed to ensure that a user has control of the email address that they are supplying. In data flow 20, Alice provides peer A personal information and e-mail address. System A generates secure credentials, encrypts personal information and sends encrypted information in an e-mail message addressed to the provided e-mail address as shown in dataflow 22. In data flow 26, Alice receives the e-mail sent by peer A. The e-mail message preferably includes an embedded hyperlink. To indicate receipt of the e-mail message, Alice clicks on the embedded hyperlink accessing a resource in system A as indicated by data flow 28. This hyperlink connects Alice to system A, which upon recognizing Alice, through use of information passed through the hyperlink, and optionally further challenge-response data, decrypts the personal information and displays it to Alice, as shown by data flow 30. Alice can then verify the accuracy of the personal information and confirm that she is who she claims to be by providing the previously submitted passphrase over data flow 32. As shown by data flow 34, upon confirmation of Alice's possession of the e-mail address, system A creates Alice's profile and locks it using her passphrase.

The system described herein can make use of the technologies described in each of RFC 2104 “HMAC: Keyed Hashing for Message Authentication”, RFC 2246 “The TLS Protocol Version 1.0”, RFC 2289 “A One-Time Password System” and RFC 3369 “Cryptographic Message Syntax (CMS)” to implement specific aspects of the present invention. One skilled in the art will appreciate that reliance upon the methods and systems described in the RFCs is not strictly required, and is instead merely preferred. The methods described in the RFCs are intended to be exemplary and not limiting, as one skilled in the art will appreciate that these results may often be achievable using other means without departing from the scope of the present invention.

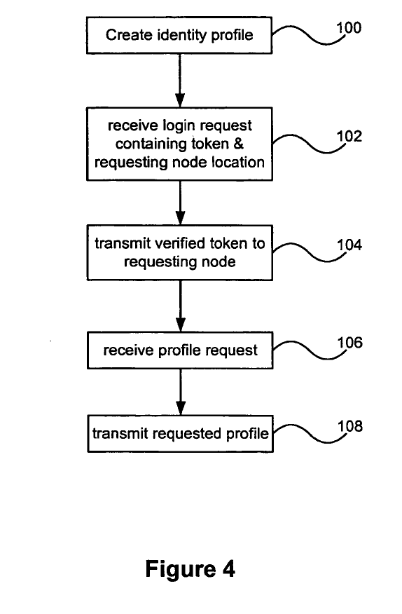

FIG. 4 illustrates a method of transferring an identity profile according to an embodiment of the present invention. In step 100, an identity profile is created. In step 102, the peer hosting the identity profile receives a log in request. This request preferably includes a token that is encrypted with a known encryption key, and a requesting node location identifier that is signed with a known encryption key. The token is decrypted and transmitted back to the requesting node in step 104. The node then receives a profile request in step 106 and transmits the profile in response to the authenticated request in step 108. One skilled in the art will appreciate that the use of known keys, such as a shared symmetric key, provides the node hosting the identity information proof that a shared secret is possessed by the requesting node. This secret was sent using an out of bound communication, and thus provides a degree of security to the system.

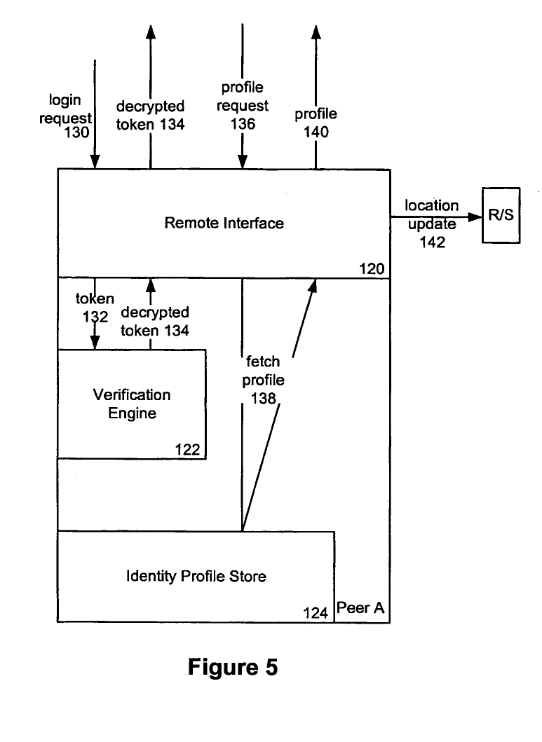

FIG. 5 illustrates a peer of the present invention for hosting and releasing a user's identity information. Peer A includes a remote request interface 120, a token verification engine 122 and an identity profile store 124. Remote request interface 120 receives a login request 130 from a remote peer. This request includes a token 132 that is passed to the token verification engine 122. Token verification engine verifies the authenticity of the token, preferably by determining if the token was encrypted using a shared secret encryption key. The verified token 134 is passed back to the remote interface. In request 120 is also provide a requesting location address, which is preferably signed to indicate that the address has not been tampered with in transit. Remote interface 120 establishes a connection with the remote requesting node and transmits the verified (decrypted) token 134. This provides the remote requesting node with proof that it has connected to the correct “home” node. Node A then receives at remote interface 120 a profile request 136. The profile is fetched 138 from the identity profile store 124, and is provided to the remote requesting node over data flow 140. In one embodiment, the remote requesting node is provided the decrypted token over a secure connection, such as an SSL link, and all future correspondence is handled in that fashion. This allows Node A and the remote requesting link to reduce the encryption and verification techniques employed to ensure that accurate connections are being maintained and that the connection is not be rerouted to a third party. Upon transmitting the profile to the remote requesting node, the home node preferably transmits information to relay server R/S over dataflow 142 updating the R/S with the address of the profile to allow network resources to find the most current or active instance of an identity, or to allow network resources to find all active instances of the profile.

By employing the transmission of a known token using a known encryption key, the remote requesting node is providing node A with proof that it possesses a shared secret. The information in the token can be the credentials associated with the identity profile store, and can also be augmented by time sensitive stamps to prevent play-back type attacks on the system. By providing a location in a signed fashion to Node A, the remote requesting node allows node A to verify that a destination address is secure, and permits Node A to create a secure connection to the remote requesting node which provides a secure channel over which the remaining data can be transmitted. This technique allows both the requesting and responding nodes to verify the identity of the other node.

It should be noted, that once a node obtains an identity profile, it can then serve as a source for another node to request the information from. This permits a chaining of profile transfers. This chain can also fork if one node provides the profile to two nodes. A user can be provided with a mechanism to contact the relay server from at least one of the nodes and to terminate the instances of the identity to provide a simplified means of logging out a large number of profiles.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A peer, for participation in a peer-to-peer network, and for remotely authenticating a request for an identity profile stored by the peer, the peer comprising:
a remote interface for receiving an authentication request for the identity profile from a remote peer, the authentication request containing a challenge response;
a verification engine for verifying the challenge response received with the authentication request; and
an identity profile store for storing the identity profile and for releasing the identity profile to the remote peer upon obtaining verification of a valid challenge response from the verification engine.

2. The peer of claim 1 wherein the identity profile store includes means to release the identity profile to the remote peer through the remote interface.

3. The peer of claim 1 wherein the challenge response is a user identifier and password combination.

4. The peer of claim 1 wherein the remote interface includes a relay server interface for providing an address associated with the remote peer to a relay server upon transmission of the identity profile to the remote peer.

5. The peer of claim 1 wherein authentication request includes an encrypted token as the challenge response.

6. The peer of claim 5 wherein the verification engine includes a decryption engine for decrypting the encrypted token to obtain a challenge response.

7. The peer of claim 6 wherein the remote interface includes means to transmit the decrypted token to the remote peer upon verification of the challenge response by the verification engine.

8. The peer of claim 7 wherein the means to transmit the decrypted token creates a secure connection to the remote peer to transfer the decrypted token.

9. A method of providing an identity profile to a requesting node in a network comprising:
receiving from the requesting node a login request containing a token having a challenge response;
verifying the challenge response in the token, and transmitting the verified token to the requesting node;
receiving a request for an identity profile associated with the verified token from the remote node in response to transmission of the verified token; and
transmitting the requested identity profile, to the requesting node.

10. The method of claim 9 wherein the received token is encrypted.

11. The method of claim 10 wherein the step of verifying the challenge response includes decrypting the token and verifying the decrypted challenge response.

12. The method of claim 9 wherein transmitting the verified token, receiving the request for the identity profile and transmitting the requested identity profile are performed over a secure transmission channel.

13. The method of claim 9 further including the step of providing a relay server with the address of the remote peer upon transmitting the requested identity profile.
